(19) United States
(12) Patent Application Publication
(10) Pub. No.: US 2025/0079981 A1
(43) Pub. Date: Mar. 6, 2025

(54) Bidirectional Charge Pump for DC Link Charging and Discharging

(71) Applicant: LEAR CORPORATION, Southfield, MI (US)

(72) Inventor: Michael HAGGERTY, Grand Blanc, MI (US)

(73) Assignee: LEAR CORPORATION, Southfield, MI (US)

(21) Appl. No.: 18/457,676

(22) Filed: Aug. 29, 2023

(51) Int. Cl. H02M 3/07; B60L 58/12; H02J 7/00; H02M 1/088

(52) U.S. Cl. CPC H02M 3/07; B60L 58/12; H02J 7/00712; H02M 1/088; H02J 2207/20

(57) ABSTRACT

A system comprises a bus and a capacitive circuit. The bus connects a battery and an impedance. The capacitive circuit is connected to the bus between the battery and the impedance. The capacitive circuit charges the impedance by using current from the battery and discharges the impedance by discharging current from the impedance through the capacitive circuit. The capacitive circuit comprises a primary switch bridge comprising a high-side switch and a low-side switch, a secondary switch bridge comprising a high-side switch and a low-side switch, and a capacitor connected between the switch bridges.

### TECHNICAL FIELD

The present disclosure relates to charging and discharging a DC link between a battery and a load.

### BRIEF DESCRIPTION OF THE DRAWINGS

FIG. 1 illustrates a block diagram of a battery electric vehicle (BEV) having an electric drive system;

FIG. 2 illustrates a block diagram of a bus of the electric drive system having a pre-charge circuit and a discharge circuit for DC link charging and discharging according to a conventional arrangement;

FIG. 3 illustrates a block diagram of the bus having a bidirectional charge pump for DC link charging and discharging;

FIG. 4A illustrates a block diagram of the bus during an initial portion of a switching cycle of the bidirectional charge pump while the bidirectional charge pump is performing a charge operation for DC link charging;

FIG. 4B illustrates a block diagram of the bus during a remaining portion of the switching cycle of the bidirectional charge pump while the bidirectional charge pump is performing the charge operation for DC link charging;

FIG. 5A illustrates a block diagram of the bus during an initial portion of a switching cycle of the bidirectional charge pump while the bidirectional charge pump is performing a discharge operation for DC link discharging; and

FIG. 5B illustrates a block diagram of the bus during a remaining portion of the switching cycle of the bidirectional charge pump while the bidirectional charge pump is performing the discharge operation for DC link discharging.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

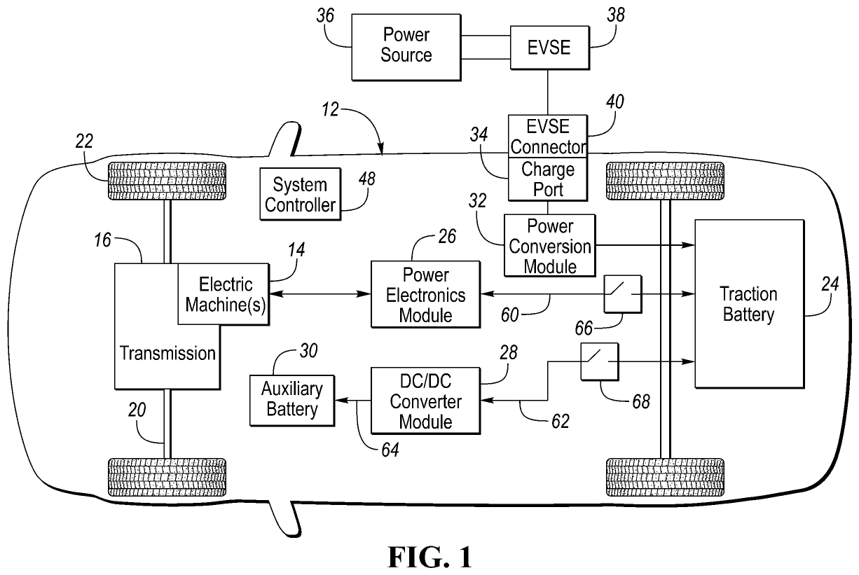

Referring now to FIG. 1, a block diagram of an electrified vehicle 12 in the form of a battery electric vehicle (BEV) is shown. BEV 12 has an electric drive system including one or more motors (“electric machine(s)”) 14, a traction battery (“battery” or “battery pack”) 24, and a power electronics module in the form of an inverter 26 (or inverter system controller (ISC)). In the BEV configuration, traction battery 24 provides all of the propulsion power with the electrified vehicle not having an engine. In other variations, the electrified vehicle is a plug-in (or non-plug-in) hybrid electric vehicle (HEV) further having an engine.

Motor 14 is part of the EDS of BEV 12 for powering movement of the BEV. In this regard, motor 14 is mechanically connected to a transmission 16 of BEV 12. Transmission 16 is mechanically connected to a drive shaft 20 that is mechanically connected to wheels 22 of BEV 12. Motor 14 can provide propulsion capability to BEV 12 but is also capable of operating as a generator. Motor 14 acting as a generator can recover energy that is normally lost as heat in a friction braking system of BEV 12.

Traction battery 24 stores electrical energy that can be used by motor 14 for propelling BEV 12. Traction battery 24 typically provides a high-voltage (HV) direct current (DC) output. Traction battery 24 is electrically connected to inverter 26. Motor 14 is also electrically connected to inverter 26. Inverter 26 provides the ability to bi-directionally transfer energy between traction battery 24 and motor 14. For example, traction battery 24 provides a DC voltage while motor 14 requires an alternating current (AC) current (e.g., a three-phase AC current) to function. Inverter 26 converts the DC voltage to a three-phase AC current to operate motor 14. In a regenerative mode, inverter 26 converts three-phase AC current from motor 14 acting as a generator to DC voltage compatible with traction battery 24.

In addition to providing electrical power for vehicle propulsion, traction battery 24 provides electrical power for other vehicle electrical systems. A typical vehicle electrical system includes a DC/DC converter module 28 that converts the HV DC output of traction battery 24 to a low-voltage (LV) DC supply compatible with other low-voltage vehicle components. Other high-voltage loads, such as compressors and electric heaters, are connected directly to the high-voltage supply without the use of DC/DC converter module 28. An auxiliary battery 30 (e.g., a twelve-volt DC battery) is charged by DC/DC converter module 28. The low-voltage vehicle components are electrically connected to auxiliary battery 30.

Traction battery 24 is rechargeable by an external power source 36 (e.g., the grid). External power source 36 is electrically connectable to electric vehicle supply equipment (EVSE) 38. EVSE 38 provides circuitry and controls to control and manage the transfer of electrical energy between external power source 36 and BEV 12. External power source 36 provides DC or AC electric power to EVSE 38. EVSE 38 has a charge connector 40 for plugging into a charge port 34 of BEV 12.

A power conversion module 32 of BEV 12, such as an on-board charger having a DC/DC converter, conditions power supplied from EVSE 38 to provide the proper voltage and current levels to traction battery 24. Power conversion module 32 interfaces with EVSE 38 to coordinate the delivery of power to traction battery 24.

The various components described above have one or more associated controllers to control and monitor the operation of the components. The controllers can be microprocessor-based devices. The controllers can communicate via a serial bus (e.g., Controller Area Network (CAN)) or via discrete conductors.

For example, a system controller 48 (“vehicle controller”) is present to coordinate the operation of the various components. Controller 48 includes electronics, software, or both, to perform the necessary control functions for operating BEV 12. In variations, controller 48 is a combination vehicle system controller and powertrain control module (VSC/PCM). Although controller 48 is shown as a single device, in variations, controller 48 includes multiple controllers in the form of multiple hardware devices, or multiple software controllers with one or more hardware devices. In this regard, a reference to a “controller” herein refers to one or more controllers.

As indicated, traction battery 24 is electrically connected to inverter 26. More particularly, as shown in FIG. 1, traction battery 24 and inverter 26 are electrically connected via a first bus 60. First bus 60 is a HV bus as traction battery 24 provides HV DC output to inverter 26 via the first bus. (Conversely, in the regenerative mode with motor 14 acting as a generator, inverter 26 provides HV DC output to traction battery 24 via first bus 60.) Similarly, traction battery 24 and DC/DC converter module 28 are electrically connected via a second bus 62 and the second bus is a HV bus as traction battery 24 provides HV DC output to DC/DC converter module 28 via the second bus. DC/DC converter module 28 and auxiliary battery 30 are electrically connected via a third bus 64. Third bus 64 is a LV bus as DC/DC converter module 28 provides LV DC output to auxiliary battery 30 via the third bus.

As further shown in FIG. 1, a first contactor circuitry 66 is associated with first HV bus 60. First contactor circuitry 66 includes a switch assembly that enables inverter 26 to be connected to, and disconnected from, traction battery 24 via first HV bus 60. Similarly, a second contactor circuitry 68 is associated with second HV bus 62. Second contactor circuitry 68 includes a switch assembly that enables DC/DC converter module 28 to be connected to, and disconnected from, traction battery 24 via second HV bus 62.

As described, inverter 26 is connectable through first HV bus 60 to traction battery 24 via first contactor circuitry 66. Inverter 26 is considered as being a load when the inverter is to receive electrical power from traction battery 24. Further, a DC (direct current) link (not shown in FIG. 1) is interposed between inverter 26 and traction battery 24. A DC link interposed between two components is a junction between the two components. In variations, the DC link includes an energy storage element which acts as a buffer for electrical power. For instance, the energy storage element is a capacitor whereby the DC link is a DC link capacitor. The DC link along with inverter 26 are connectable through first HV bus 60 to traction battery 24 via first contactor circuitry 66.

Likewise, DC/DC converter module 28 is connectable through second HV bus 62 to traction battery 24 via second contactor circuitry 68. DC/DC converter module 28 is considered as being a load when the DC/DC converter module is to receive electrical power from traction battery 24. Further, a second DC link (not shown in FIG. 1) is interposed between DC/DC converter module 28 and traction battery 24. The second DC link along with DC/DC converter module 28 are connectable through second HV bus 62 to traction battery 24 via second contactor circuitry 68.

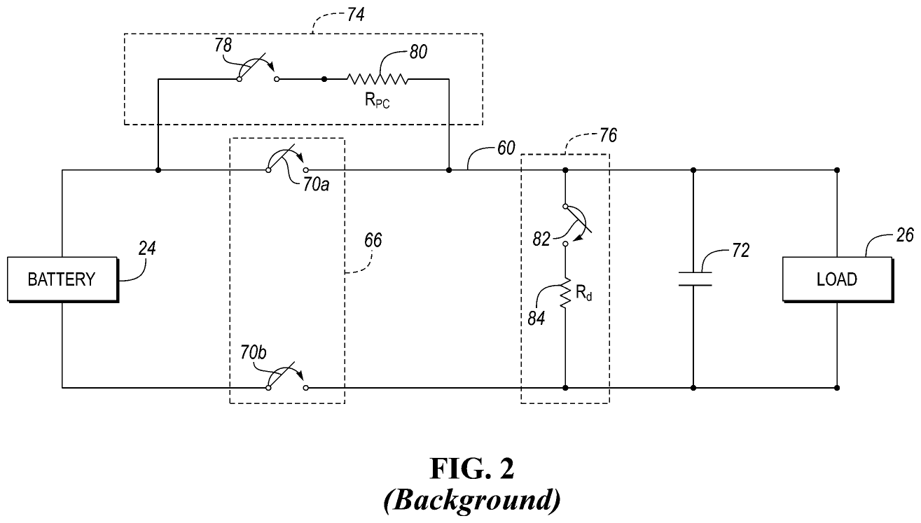

As an overview, in an EV system (e.g., the electric drive system of BEV 10), a DC link between a HV battery (e.g., traction battery 24) and a HV load (e.g., inverter 26) is connected and disconnected through HV contactors (e.g., first contactor circuitry 66). In order to mitigate the risk of contactor weld when the bus (e.g., first HV bus 60) contains an appreciable amount of X-capacitance (e.g., a charged DC link capacitor), a circuit to charge the bus is required. This pertains to a bus charge (or pre-charge) operation. As explained with reference to FIG. 2, for the bus charge operation, existing solutions utilize a pre-charge circuit having a switch and a resistor to limit the capacitive inrush current. Conversely, when a bus disconnection is commanded, the DC link X-capacitance is required to be discharged (e.g., the DC link capacitor is required to be discharged). This pertains to a bus discharge operation. Existing solutions, for the bus discharge operation, utilize a discharge circuit having a switch and a resistor to reverse the operation performed in the bus pre-charge.

Referring now to FIG. 2, with continual reference to FIG. 1, a block diagram of a bus of the electric drive system having a pre-charge circuit 74 and a discharge circuit 76 for DC link charging and discharging according to a conventional arrangement is shown. As an example, the bus is first HV bus 60 between traction battery 24 and inverter 26, and the inverter is designated as being a load.

As shown in FIG. 2, the switch assembly of first contactor circuitry 66 associated with first HV bus 60 includes a positive main contactor 70a and a negative main contactor 70b. When main contactors 70a, 70b are closed, traction battery 24 and inverter 26 are electrically connected through first HV bus 60.

As further shown in FIG. 2, the electric drive system further includes a DC link 72. DC link 72 is interposed along first HV bus 60 between traction battery 24 and inverter 26. DC link 72 can include one or any number of parallel connected capacitors and/or other energy storage elements. More generally, DC link 72 is part of an electrical impedance of devices (e.g., inverter, DC/DC conversion module, etc.) that are connected to the bus. In variations, the electrical impedance is comprised of separate power electronics devices, each having its own capacitance associated with it. As referenced above, in variations, capacitance is added to smooth and filter the bus voltage. For ease of reference, DC link 72 will be considered as being a DC link capacitor.

Pre-charge circuit 74 pertains to the charge (or pre-charge) operation of first HV bus 60 whereby DC link capacitor 72 is to be charged to a requisite charge level by traction battery 24. Pre-charge circuit 74 is arranged to limit the DC current received by DC link capacitor 72 from traction battery 24. Pre-charge circuit 74 includes a pre-charge switch 78 and a pre-charge resistor (R_{pc}) 80 connected in series. For the charge operation, positive main contactor 70a is opened and negative main contactor 70b and pre-charge switch 78 are closed thereby electrically connecting traction battery 24 to inverter 26 via pre-charge circuit 74. This causes DC link capacitor 72 to acquire charge from traction battery 24 relatively slowly due to the presence of pre-charge resistor 80. Once DC link capacitor 72 has acquired charge sufficiently equal to that of traction battery 24, pre-charge resistor 80 is opened. Positive main contactor 70a is then closed for ordinary operation, i.e., operation other than pre-charge operation or discharge operation, of first HV bus 60 to occur.

Discharge circuit 76 pertains to the discharge operation of first HV bus 60 whereby DC link capacitor 72 is to be discharged. Discharge circuit 76 includes a discharge switch 82 and a discharge resistor (Ra) 84 connected in series. For the discharge operation, main contactors 70a, 70b are opened, thereby electrically disconnecting traction battery 24 from inverter 26, and discharge switch 82 is closed. This causes DC link capacitor 72 to discharge via discharge resistor 84.

Pre-charge circuit 74 and discharge circuit 76 being shown in FIG. 2 as separate circuits according to the conventional arrangement is intended to readily illustrate how the charge and discharge operations occur. In other arrangements, discharge circuit 76 is eliminated with discharge switch 82 being arranged within pre-charge circuit 74 and charge resistor 80 of the pre-charge circuit being additionally used to discharge DC link capacitor 72.

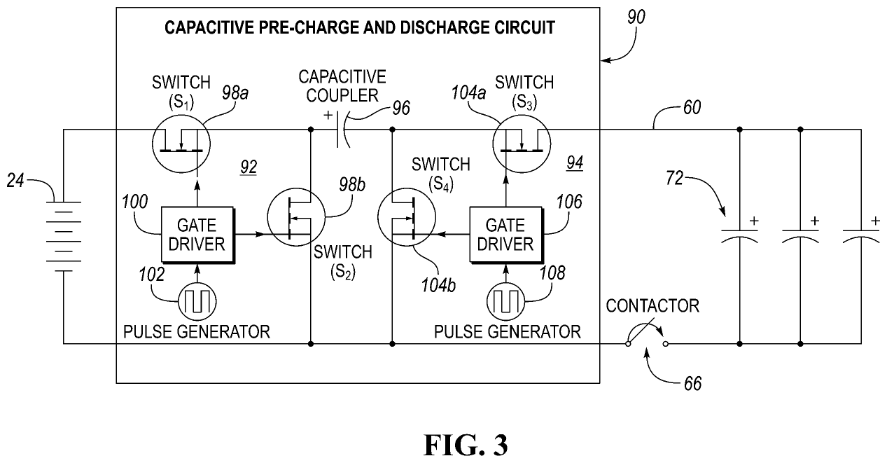

Referring now to FIG. 3, with continual reference to FIGS. 1 and 2, a block diagram of a bus of the electric drive system having a bidirectional charge pump 90 for DC link charging and discharging is shown. Again, as an example, the bus is first HV bus 60. First contactor circuitry 66 associated with first HV bus 60 is represented in FIG. 2 as a single contactor. DC link capacitor 72 is shown in FIG. 2 as being comprised of a plurality of parallel connected capacitors.

Bidirectional charge pump 90 is an electronic capacitive pre-charge and discharge circuit for charging and discharging the HVDC link X-capacitance (e.g., DC link capacitor 72). Bidirectional charge pump 90, compared with the conventional switch and resistor approach such as embodied by pre-charge circuit 74 and discharge circuit 76, has a reduced size, weight, and cost and an increased reliability.

Bidirectional charge pump 90 includes a primary side (primary bridge) 92, a secondary side (secondary bridge) 94, and a capacitor (bridge capacitance) 96. Capacitor 96 (i.e., a capacitive coupler) is connected between primary side 92 and secondary side 94. As such, as arranged in first HV bus 60, primary side 92 is between traction battery 24 and capacitive coupler 96 whereas secondary side 94 is between capacitive coupler 96 and DC link capacitor 72.

Primary side 92 includes a first set of switches having a first switch (S1) 98a and a second switch (S2) 98b. Primary side 92 further includes a first gate driver 100. First gate driver 100 is operable to close and open individually each of first switch 98a and second switch 98b in accordance with gate drive signals received from a first pulse generator 102. First pulse generator 102 is, for instance, implemented by controller 48. Likewise, secondary side 94 includes a second set of switches having a third switch (S3) 104a and a fourth switch (S4) 104b. Secondary side 94 further includes a second gate driver 106. Second gate driver 106 is operable to close and open individually each of third switch 104a and fourth switch 104b in accordance with gate drive signals received from a second pulse generator 108. Second pulse generator 108 is, for instance, implemented by controller 48.

Bidirectional charge pump 90 leverages the capacitive charge pump with a few subtle differences. One difference is that rather than being used a typical voltage doubler, the first set of switches 98a and 98b on primary side 92 of capacitive coupler 96 are set to provide a unity voltage gain. Another difference is that rather than utilizing diodes on secondary side 94 of capacitive coupler 96 to rectify the pumped charge, the second set of switches 104a and 104b are used for improving secondary side conduction losses and efficiency and for enabling bidirectional operation so that bidirectional charge pump 90 can provide discharge functions, in addition to charge functions, on the same bus.

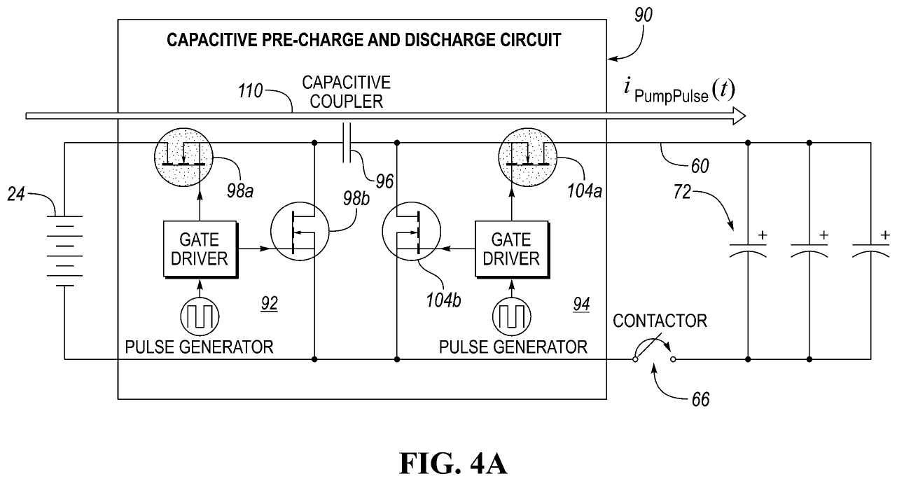

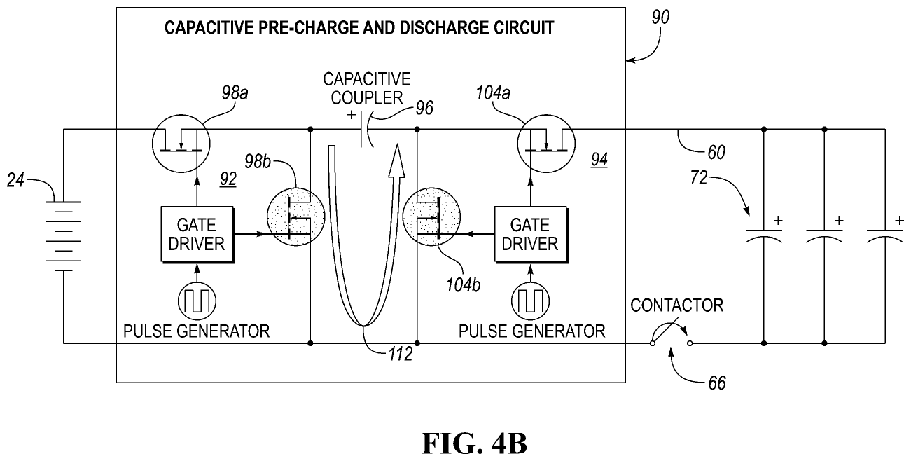

Referring now to FIGS. 4A and 4B, block diagrams of first HV bus 60 during a switching cycle of bidirectional charge pump 90 while the bidirectional charge pump is performing a charge operation for charging DC link capacitor 72 is shown. The block diagram of FIG. 4A depicts first HV bus 60 during an initial portion of the charge operation switching cycle. The block diagram of FIG. 4B depicts first HV bus 60 during a remaining portion of the charge operation switching cycle.

As indicated in FIG. 4A, during the initial portion of the charge operation switching cycle, the high-side switches on both primary and secondary sides 92 and 94 of bidirectional charge pump 90 are activated (i.e., closed) while the low-side switches on both primary and secondary sides 92 and 94 of the bidirectional charge pump are not activated (i.e., opened). (Note that a “high-side” switch is a switch that connects to a voltage supply (i.e., traction battery 24) or an electrical impedance (i.e., DC link capacitor 72) whereas a “low-side” switch is a switching to ground.) Put another way, first switch 98a of primary side 92 and third switch 104a of secondary side 94 are closed while second switch 98b of the primary side and fourth switch 104b of the secondary side are opened. As high-side switches 98a and 104a are closed and low-side switches 98b and 104b are opened, a current (i_{PumpPulse}(t)) 110 flows from traction battery 24 to DC link capacitor 72 during the initial portion of the charge operation switching cycle. The amplitude of current 110 is determined by the transconductance of high-side switches 98a and 104a and capacitive coupler 96. The real time value of current 110 is given by the following equation:

$${i}_{PumpPulse} ( t ) = {C}_{Coupler} * \frac{δ}{δ t} ( VBattery - VDS - VDCLink ) \qquad ( 1 )$$

where i_{PumpPulse}(t) is current 110, C_{Coupler} is the capacitance of capacitive coupler 96, VBattery is the voltage of traction battery 24, VDS is the voltage drop across high-side switches 98a and 104a, and VDCLink is the voltage of DC link capacitor 72.

As set forth, during the charging operation, the initial portion of the charge operation switching cycle pertains to a charging direction positive pulse operation.

As indicated in FIG. 4B, during the remaining portion of the charge operation switching cycle, the low-side switches on both primary and secondary sides 92 and 94 of bidirectional charge pump 90 are activated while the high-side switches on both primary and secondary sides 92 and 94 of the bidirectional charge pump are not activated. Put another way, second switch 98b of primary side 92 and fourth switch 104b of secondary side 94 are closed while first switch 98a of the primary side and third switch 104a of the secondary side are opened. As low-side switches 98b and 104b are closed and high-side switches 98a and 104a are opened, a current 112 is caused to flow from one side of capacitive coupler 96 (capacitive coupler 96 having been charged by current 110 during the initial portion of the charge operation switching cycle) to the other side of the capacitive coupler. In this way, capacitive coupler 96 is discharged thereby resetting the initial condition of the capacitive coupler for the next charge operation switching cycle. As set forth, during the charging operation, the remaining portion of the charge operation switching cycle pertains to a resetting operation.

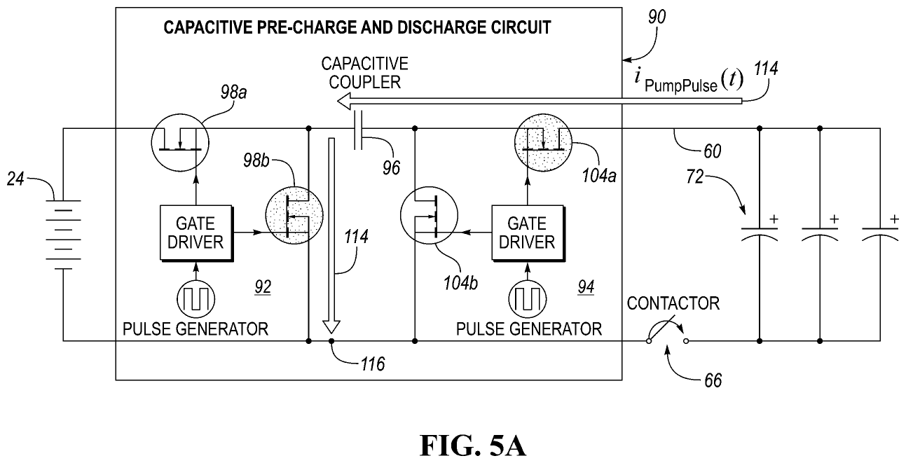

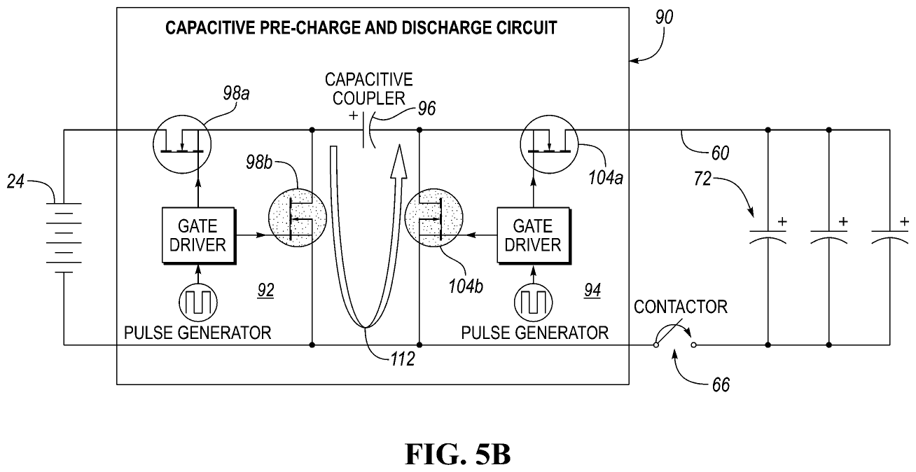

Referring now to FIGS. 5A and 5B, block diagrams of first HV bus 60 during a switching cycle of bidirectional charge pump 90 while the bidirectional charge pump is performing a discharge operation for discharging DC link capacitor 72 is shown. The block diagram of FIG. 5A depicts first HV bus 60 during an initial portion of the discharge operation switching cycle. The block diagram of FIG. 5B depicts first HV bus 60 during a remaining portion of the discharge operation switching cycle.

As indicated in FIG. 5A, during the initial portion of the discharge operation switching cycle, the low-side switch on primary side 92 and the high-side switch on secondary side 94 are activated (i.e., closed) while the high-side switch on the primary side and the low-side switch on the secondary side are not activated (i.e., opened). Put another way, second switch 98b of primary side 92 and third switch 104a of secondary side 94 are closed while first switch 98a of the primary side and fourth switch 104b of the secondary side are opened. As second switch 98b and third switch 104a are closed and first switch 98a and fourth switch 104b are opened, a current (i_{PumpPulse}(t)) 114 flows from DC link capacitor 72 to an HVDC equipotential point 116 during the initial portion of the discharge operation switching cycle. The amplitude of current 114 is determined by the transconductance of second switch 98b and third switch 104a and capacitive coupler 96. The real time value of current 114 is given by the following equation:

$${i}_{PumpPulse} ( t ) = {C}_{Coupler} * \frac{δ}{δ t} ( VDCLink - VDS ) \qquad ( 2 )$$

where i_{PumpPulse}(t) is current 114, C_{Coupler} is the capacitance of capacitive coupler 96, VDS is the voltage drop across second switch 98b and third switch 104a, and VDCLink is the voltage of DC link capacitor 72.

As set forth, during the discharging operation, the initial portion of the discharge operation switching cycle pertains to a discharging direction positive pulse operation.

As indicated in FIG. 5B, during the remaining portion of the discharge operation switching cycle, the low-side switches on both primary and secondary sides 92 and 94 are activated while the high-side switches on both primary and secondary sides 92 and 94 are not activated. Put another way, second switch 98b of primary side 92 and fourth switch 104b of secondary side 94 are closed while first switch 98a of the primary side and third switch 104a of the secondary side are opened. As low-side switches 98b and 104b are closed and high-side switches 98a and 104a are opened, current 112 is caused to flow from one side of capacitive coupler 96 to the other side of the capacitive coupler. In this way, capacitive coupler 96 is discharged thereby resetting the initial condition of the capacitive coupler for the next charge operation switching cycle. As set forth, during the discharging operation, the remaining portion of the discharge operation switching cycle pertains to a resetting operation.

Item 1: In one embodiment, the present disclosure provides a system comprising a bus connecting a battery and an impedance, the system further comprising a capacitive circuit connected to the bus between the battery and the impedance, the capacitive circuit charging the impedance by using current from the battery and discharging the impedance by discharging current from the impedance through the capacitive circuit.

Item 2: In another embodiment, the present disclosure provides the system according to Item 1, wherein the capacitive circuit charges the impedance at a rate slower than a rate at which the battery would otherwise charge the impedance.

Item 3: In another embodiment, the present disclosure provides the system according to any preceding Item, wherein the capacitive circuit comprises a capacitor.

Item 4: In another embodiment, the present disclosure provides the system according to Item 3, wherein the capacitive circuit further comprises a primary bridge comprising switches and a secondary bridge comprising switches, the capacitor being connected between the primary bridge and the secondary bridge.

Item 5: In another embodiment, the present disclosure provides the system according to Item 4, wherein the switches of the primary bridge comprise a first high-side switch and a first low-side switch, and the switches of the secondary bridge comprise a second high-side switch and a second low-side switch.

Item 6: In another embodiment, the present disclosure provides the system according to Item 5, wherein the capacitive circuit charges the impedance by using current from the battery by the switches of the primary and secondary bridges being controlled according to a charge operation switching cycle in which (i) during an initial portion of the charge operation switching cycle the high-side switches are switched closed and the low-side switches are switched opened and (ii) during a remaining portion of the charge operation switching cycle the low-side switches are switched closed and the high-side switches are switched opened.

Item 7: In another embodiment, the present disclosure provides the system according to Item 6, wherein a first current flows the battery to the impedance via the switched closed high-side switches and the capacitor during the initial portion of the charge operation switching cycle, and a second current flows from one side of the capacitor to the other side of the capacitor during the remaining portion of the charge operation switching cycle.

Item 8: In another embodiment, the present disclosure provides the system according to Item 7, wherein the first current is defined by the equation:

$${i}_{PumpPulse} ( t ) = {C}_{Coupler} * \frac{δ}{δ t} ( VBattery - VDS - VDCLink )$$

where i_{PumpPulse}(t) is the first current, C_{Coupler} is a capacitance of the capacitor, VBattery is a voltage of the battery, VDS is a voltage drop across the switched closed high-side switches, and VDCLink is a voltage of the impedance.

Item 9: In another embodiment, the present disclosure provides the system according to Item 5, wherein the capacitive circuit discharges the impedance by discharging current from the impedance through the capacitive circuit by the switches of the primary and secondary bridges being controlled according to a discharge operation switching cycle in which (i) during an initial portion of the discharge operation switching cycle the first low-side switch of the primary bridge and the second high-side switch of the secondary bridge are switched closed and the first high-side switch of the primary bridge and the low-side switch of the secondary bridge are switched opened and (ii) during a remaining portion of the discharge operation switching cycle the low-side switches are switched closed and the high-side switches are switched opened.

Item 10: In another embodiment, the present disclosure provides the system according to Item 9, wherein a first current flows from the impedance to an equipotential point via the switched closed high-side switch of the secondary bridge, the capacitor, and the switched closed low-side bridge of the primary bridge during the initial portion of the discharge operation switching cycle, and a second current flows from one side of the capacitor to the other side of the capacitor during the remaining portion of the discharge operation switching cycle.

Item 11: In another embodiment, the present disclosure provides the system according to Item 10, wherein the first current is defined by the equation:

$${i}_{PumpPulse} ( t ) = {C}_{Coupler} * \frac{δ}{δ t} ( VDCLink - VDS )$$

where i_{PumpPulse}(t) is the first current, C_{Coupler} is a capacitance of the capacitor, VDCLink is a voltage of the impedance, and VDS is a voltage drop across the switched closed high-side switch of the secondary bridge and the switched closed low-side switch of the primary bridge.

Item 12: In another embodiment, the present disclosure provides the system according to Item 5, wherein the first high-side switch and the first low-side switch of the primary bridge are set to provide a unity voltage gain.

Item 13: In another embodiment, the present disclosure provides the system according to Item 5, wherein the primary bridge further comprises a first gate driver to control switching of the first high-side switch and the first low-side switch of the primary bridge, and the secondary bridge further comprises a second gate driver to control switching of the second high-side switch and the second low-side switch of the secondary bridge.

Item 14: In another embodiment, the present disclosure provides the system according to Item 4, the secondary bridge is devoid of any diodes.

Item 15: In another embodiment, the present disclosure provides the system according to any preceding Item, the capacitive circuit is a resistor-less circuit.

Item 16: In another embodiment, the present disclosure provides the system according to any preceding Item, the impedance is a DC link capacitor.

Item 17: In another embodiment, the present disclosure provides a circuit comprising a primary switch bridge comprising a high-side switch and a low-side switch, a secondary switch bridge comprising a high-side switch and a low-side switch, and a capacitor connected between the switch bridges.

Item 18: In another embodiment, the present disclosure provides the circuit according to Item 17, wherein the high-side switch and the low-side switch of the primary bridge are set to provide a unity voltage gain.

Item 19: In another embodiment, the present disclosure provides the circuit according to any preceding Item, wherein the circuit is a resistor-less and a diode-less circuit.

Item 20: In another embodiment, the present disclosure provides a non-transitory computer readable storage medium having stored computer executable instructions to cause a capacitive circuit to charge an impedance connected to a battery via a bus by using current from the battery through the capacitive circuit and to discharge the impedance by discharging current from the impedance through the capacitive circuit.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a bus connecting a battery and an impedance; and
a capacitive circuit connected to the bus between the battery and the impedance, the capacitive circuit charging the impedance by using current from the battery and discharging the impedance by discharging current from the impedance through the capacitive circuit.

2. The system of claim 1 wherein:
the capacitive circuit charges the impedance at a rate slower than a rate at which the battery would otherwise charge the impedance.

3. The system of claim 1 wherein:
the capacitive circuit comprises a capacitor.

4. The system of claim 3 wherein:
the capacitive circuit further comprises a primary bridge comprising switches and a secondary bridge comprising switches, the capacitor being connected between the primary bridge and the secondary bridge.

5. The system of claim 4 wherein:
the switches of the primary bridge comprise a first high-side switch and a first low-side switch, and the switches of the secondary bridge comprise a second high-side switch and a second low-side switch.

6. The system of claim 5 wherein:
the capacitive circuit charges the impedance by using current from the battery by the switches of the primary and secondary bridges being controlled according to a charge operation switching cycle in which (i) during an initial portion of the charge operation switching cycle the high-side switches are switched closed and the low-side switches are switched opened and (ii) during a remaining portion of the charge operation switching cycle the low-side switches are switched closed and the high-side switches are switched opened.

7. The system of claim 6 wherein:
a first current flows from the battery to the impedance via the switched closed high-side switches and the capacitor during the initial portion of the charge operation switching cycle, and a second current flows from one side of the capacitor to the other side of the capacitor during the remaining portion of the charge operation switching cycle.

8. The system of claim 7 wherein:
the first current is defined by the equation:
$${i}_{PumpPulse} ( t ) = {C}_{Coupler} * \frac{δ}{δ t} ( VBattery - VDS - VDCLink )$$
where i_{PumpPulse}(t) is the first current, C_{Coupler} is a capacitance of the capacitor, VBattery is a voltage of the battery, VDS is a voltage drop across the switched closed high-side switches, and VDCLink is a voltage of the impedance.

9. The system of claim 5 wherein:
the capacitive circuit discharges the impedance by discharging current from the impedance through the capacitive circuit by the switches of the primary and secondary bridges being controlled according to a discharge operation switching cycle in which (i) during an initial portion of the discharge operation switching cycle the first low-side switch of the primary bridge and the second high-side switch of the secondary bridge are switched closed and the first high-side switch of the primary bridge and the low-side switch of the secondary bridge are switched opened and (ii) during a remaining portion of the discharge operation switching cycle the low-side switches are switched closed and the high-side switches are switched opened.

10. The system of claim 9 wherein:
a first current flows from the impedance to an equipotential point via the switched closed high-side switch of the secondary bridge, the capacitor, and the switched closed low-side bridge of the primary bridge during the initial portion of the discharge operation switching cycle, and a second current flows from one side of the capacitor to the other side of the capacitor during the remaining portion of the discharge operation switching cycle.

11. The system of claim 10 wherein:
the first current is defined by the equation:
$${i}_{PumpPulse} ( t ) = {C}_{Coupler} * \frac{δ}{δ t} ( VDCLink - VDS )$$
where i_{PumpPulse}(t) is the first current, C_{Coupler} is a capacitance of the capacitor, VDCLink is a voltage of the impedance, and VDS is a voltage drop across the switched closed high-side switch of the secondary bridge and the switched closed low-side switch of the primary bridge.

12. The system of claim 5 wherein:
the first high-side switch and the first low-side switch of the primary bridge are set to provide a unity voltage gain.

13. The system of claim 5 wherein:
the primary bridge further comprises a first gate driver to control switching of the first high-side switch and the first low-side switch of the primary bridge; and
the secondary bridge further comprises a second gate driver to control switching of the second high-side switch and the second low-side switch of the secondary bridge.

14. The system of claim 4 wherein:
the secondary bridge is devoid of any diodes.

15. The system of claim 1 wherein:
the capacitive circuit is a resistor-less circuit.

16. The system of claim 1 wherein:
the impedance is a DC link capacitor.

17. A circuit comprising:
a primary switch bridge comprising a high-side switch and a low-side switch;
a secondary switch bridge comprising a high-side switch and a low-side switch; and
a capacitor connected between the switch bridges.

18. The circuit of claim 17 wherein:
the high-side switch and the low-side switch of the primary bridge are set to provide a unity voltage gain.

19. The circuit of claim 17 wherein:
the circuit is a resistor-less and a diode-less circuit.

20. A non-transitory computer readable storage medium having stored computer executable instructions to cause a capacitive circuit to:
charge an impedance connected to a battery via a bus by using current from the battery through the capacitive circuit; and
discharge the impedance by discharging current from the impedance through the capacitive circuit.
